(19) United States
(12) Patent Application Publication
(10) Pub. No.: US 2023/0349210 A1
(43) Pub. Date: Nov. 2, 2023

(54) DOOR STOPPER AND OFF-ROAD VEHICLE

(71) Applicant: KAWASAKI MOTORS, LTD., Hyogo (JP)

(72) Inventor: Naoto NAKAGAWA, Akashi-shi (JP)

(73) Assignee: KAWASAKI MOTORS, LTD., Hyogo (JP)

(21) Appl. No.: 17/731,120

(22) Filed: Apr. 27, 2022

(51) Int. Cl. E05C 17/24

(52) U.S. Cl. CPC E05C 17/24; B60J 5/0486

(57) ABSTRACT

A door stopper includes a stopper provided at a first object that is one of a vehicle body or a door and a rod rotatably provided at a second object that is the other one of the vehicle body or the door. The rod has a first portion and a second portion bent from the first portion and rotatably supported by the second object. The first portion of the rod and the stopper move relative to each other according to opening or closing of the door. The first portion of the rod engages with the stopper when the door is opened to a predetermined degree of opening. The door stopper restricts the relative movement of the first portion and the stopper by engagement between the first portion and the stopper to limit the degree of opening of the door.

### FIELD

The technique disclosed herein relates to a door stopper and an off-road vehicle.

### BACKGROUND

Patent Document 1 (Japanese Unexamined Patent Application Publication No. 2007-321365) discloses a door checker that limits the degree of opening of a door attached to a vehicle body. The door checker includes a hinge portion fixed to the vehicle body, an arm portion rotatably coupled to the hinge portion at one end portion and provided with a stopper portion at the other end portion, and a sliding member fixed to the door. The arm portion penetrates the sliding member. The sliding member slides in an arm portion length direction according to door opening/closing motion. When the door is opened to a predetermined degree of opening, the sliding member contacts the stopper portion. With this configuration, the degree of opening of the door is limited.

### SUMMARY

Such a door checker includes a great number of components, and for this reason, the structure of the door checker is complicated and the cost for the door checker is high.

The technique disclosed herein has been made in view of the above-described points, and an object of the technique is to provide a door stopper capable of limiting the degree of opening of a door with a simple configuration and an off-road vehicle including the door stopper.

The door stopper disclosed herein includes a stopper provided at a first object that is one of a vehicle body or a door and a rod rotatably provided at a second object that is the other one of the vehicle body or the door. The rod has a first portion and a second portion bent from the first portion and rotatably supported by the second object. The first portion of the rod and the stopper move relative to each other according to opening or closing of the door. The first portion of the rod engages with the stopper when the door is opened to a predetermined degree of opening. The door stopper restricts the relative movement of the first portion and the stopper by engagement between the first portion and the stopper to limit the degree of opening of the door.

The off-road vehicle disclosed herein includes a vehicle body, a door, and a door stopper. The door stopper has a stopper provided at a first object that is one of the vehicle body or the door and a rod rotatably provided at a second object that is the other one of the vehicle body or the door. The rod has a first portion and a second portion bent from the first portion and rotatably supported by the second object. The first portion of the rod and the stopper move relative to each other according to opening or closing of the door. The first portion of the rod engages with the stopper when the door is opened to a predetermined degree of opening. The door stopper restricts the relative movement of the first portion and the stopper by engagement between the first portion and the stopper to limit the degree of opening of the door.

The door stopper can limit the degree of opening of the door with a simple configuration.

The off-road vehicle can limit the degree of opening of the door with a simple configuration.

### BRIEF DESCRIPTION OF THE DRAWINGS

FIG. 1 is a perspective view of a utility vehicle.

FIG. 2 is a perspective view showing a door stopper and components at the periphery of the door stopper.

FIG. 3 is a perspective view showing the door stopper when a door is closed.

FIG. 4 is a perspective view showing the door stopper when the door is opened.

FIG. 5 is an enlarged plan view of a stopper and a rod.

FIG. 6 is a plan view of the door stopper when the door is closed.

FIG. 7 is a plan view of the door stopper when the door is opened.

FIG. 8 is a plan view of a door stopper of a variation.

### DESCRIPTION OF EMBODIMENTS

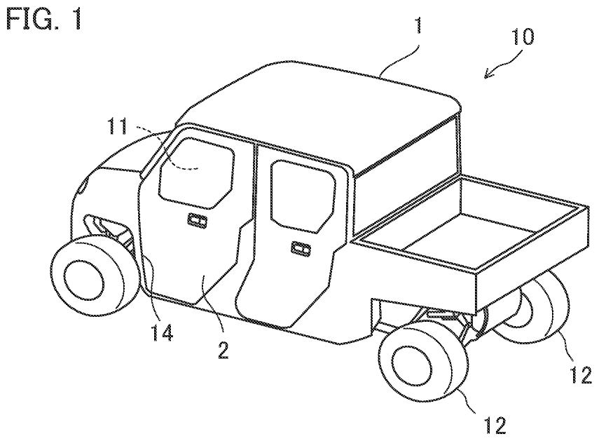

Hereinafter, an exemplary embodiment will be described in detail based on the drawings. FIG. 1 is a perspective view of a utility vehicle 10. The utility vehicle 10 can travel off road. The utility vehicle 10 is one example of an off-road vehicle. Note that in the present disclosure, each configuration of the utility vehicle 10 will be described using a direction when the utility vehicle 10 is arranged on the horizontal plane. Specifically, a side in the direction of forward movement of the utility vehicle 10 is defined as forward, and a right-left direction when facing forward is defined as a right-left direction.

The utility vehicle 10 of this example is a four-wheeled vehicle. The utility vehicle 10 includes a vehicle body 1 provided with a vehicle compartment 11, wheels 12 provided on the vehicle body 1, and doors 2 provided so as to rotate relative to the vehicle body 1.

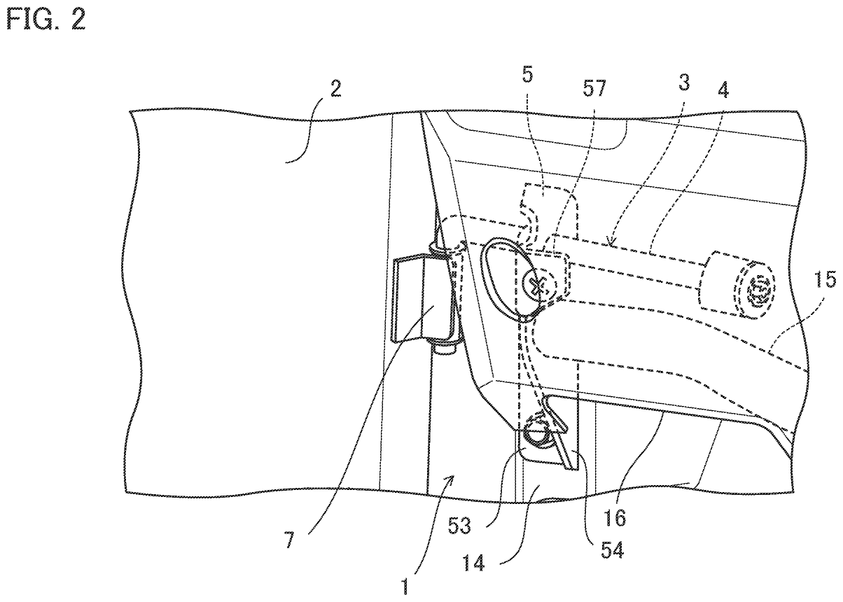

FIG. 2 is a perspective view showing the door 2 and a dashboard 16. The vehicle body 1 has right and left front pillars 14 positioned at a front end portion of the vehicle compartment 11 and a dashboard frame 15 coupled to the right and left front pillars 14. The front pillar 14 is one example of a first frame. The dashboard frame 15 is one example of a second frame. The dashboard 16 defining a front portion of the vehicle compartment 11 is attached to the dashboard frame 15. The dashboard 16 is positioned at the rear of the dashboard frame 15, and covers the dashboard frame 15.

The door 2 is a side door defining a side portion of the vehicle compartment 11. A rotation axis of the door 2 is positioned at a front end portion of the door 2. The rotation axis of the door 2 is substantially parallel with an up-down direction.

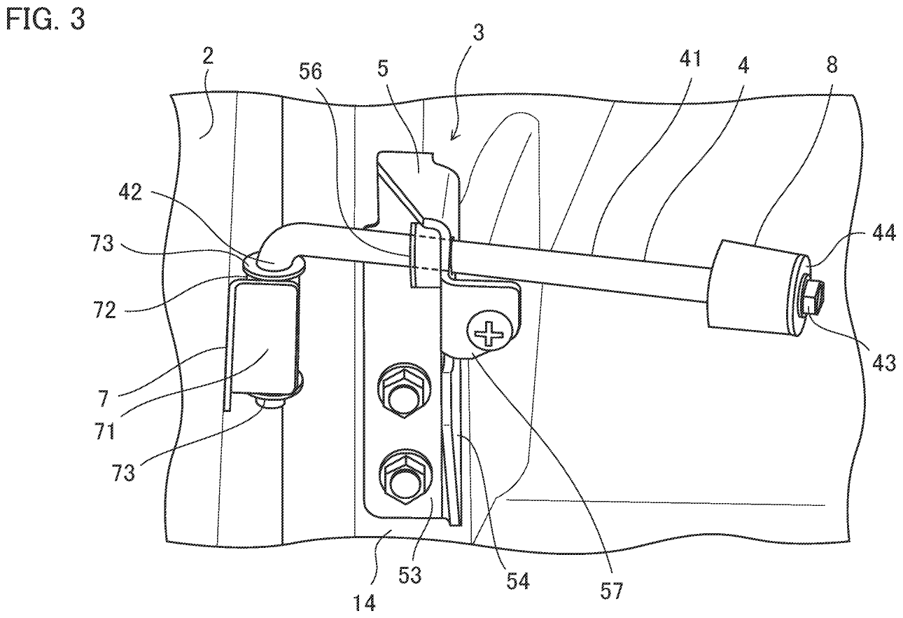

FIG. 3 is a perspective view showing a door stopper 3 when the door 2 is closed. Note that FIG. 3 does not show the dashboard 16 and the dashboard frame 15. The utility vehicle 10 further includes the door stoppers 3 that limit the degrees of opening of the doors 2. The door stoppers 3 are each provided at the doors 2 provided at the front portion of the vehicle compartment 11, i.e., front side doors. The door stopper 3 includes a stopper 5 provided at the vehicle body 1 and a rod 4 rotatably provided at the door 2 and moving relative to the stopper 5 according to opening or closing of the door 2. Note that “relative movement” in the present disclosure means a relative position change of two members. That is, “relative movement” includes both a relative position change of the stopper 5 and the rod 4 by movement of the rod 4 and a relative position change of the stopper 5 and the rod 4 by movement of the stopper 5.

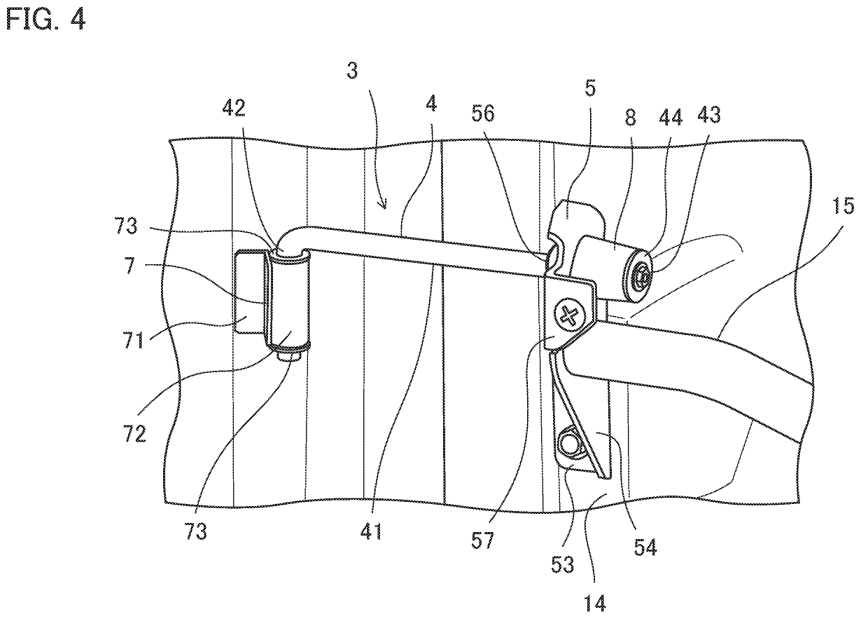

FIG. 4 is a perspective view of the door stopper 3 when the door 2 is opened. Note that FIG. 4 does not show the dashboard 16. The stopper 5 is provided at the front pillar 14. Specifically, the stopper 5 has an attachment piece 53 to be attached to the front pillar 14 and a restriction piece 54 that restricts the relative movement of the stopper 5 and the rod 4. The stopper 5 may further have a guide 56 that defines the direction of the relative movement of the stopper 5 and the rod 4. The stopper 5 may further have a fixing piece 57 to which the dashboard 16 is to be attached.

The attachment piece 53 of the stopper 5 is arranged along the front pillar 14. The attachment piece 53 is, for example, attached to the front pillar 14 with a bolt and a nut.

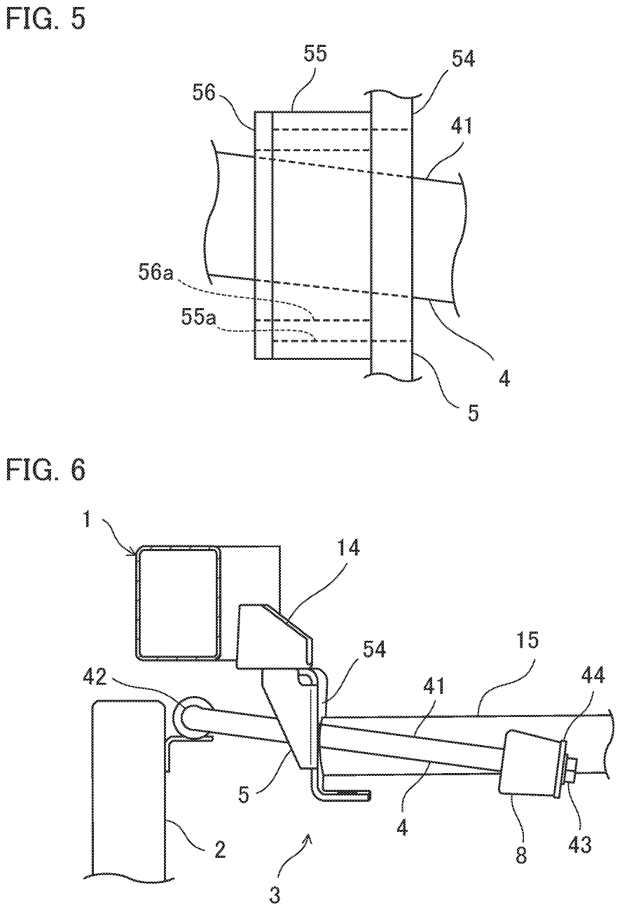

FIG. 5 is an enlarged plan view of the stopper 5 and the rod 4. The restriction piece 54 is bent from the attachment piece 53, and extends rearward of the front pillar 14. In this example, the restriction piece 54 is coupled to the dashboard frame 15. The restriction piece 54 is, for example, coupled to the dashboard frame 15 by welding. The attachment piece 53 and the restriction piece 54 of the stopper 5 function as a bracket connecting the front pillar 14 and the dashboard frame 15 to each other. That is, the stopper 5 includes the bracket connecting the front pillar 14 and the dashboard frame 15 to each other. As shown in FIG. 5, the restriction piece 54 is provided with a tubular collar 55. A hole 55a is formed in the collar 55 and the restriction piece 54 to penetrate the collar 55 and the restriction piece 54 in the right-left direction.

The guide 56 is provided at the restriction piece 54. The guide 56 is a cylindrical bush. The guide 56 is, for example, made of resin. The guide 56 is fitted in the hole 55a, and accordingly, is fixed to the collar 55. A guide hole 56a is formed in the guide 56 to penetrate the guide 56 in the right-left direction.

As shown in FIG. 3, the fixing piece 57 extends from the restriction piece 54 to the side opposite to the door 2. The dashboard 16 is, for example, attached to the fixing piece 57 with a screw. The dashboard 16 is positioned at the rear of the stopper 5, and covers part of the stopper 5.

The rod 4 is, for example, made of metal. In this example, the rod 4 is an L-shaped bar. The rod 4 has a first portion 41 extending in a bar shape and a second portion 42 bent from the first portion 41 and extending in a bar shape.

The first portion 41 of the rod 4 extends linearly. The first portion 41 penetrates the guide hole 56a of the stopper 5. The first portion 41 is movable relative to the guide 56 in a direction substantially coincident with a length direction of the first portion 41.

The second portion 42 extends in a direction crossing the length direction of the first portion 41, and is rotatably supported by the door. Specifically, the second portion 42 extends linearly in a direction substantially perpendicular to the length direction of the first portion 41. The second portion 42 is formed integrally with the first portion 41.

The second portion 42 is rotatably supported by a supporter 7 provided at the door 2. The supporter 7 is provided on an inner surface of the door 2. The supporter 7 has a bracket 71 fixed to the door 2, a penetrating tubular collar 72 fixed to the bracket 71 and extending in a rotation axis direction of the door 2, and bushes 73 each fitted onto upper and lower end portions of the collar 72. The second portion 42 penetrates each bush 73. Each bush 73 rotatably supports the second portion 42. The second portion 42 rotates about the axis thereof. The rotation axis of the second portion 42 is substantially parallel with the rotation axis of the door 2.

The rod 4 and the stopper 5 move relative to each other according to opening or closing of the door 2. That is, when the door 2 is opened or closed, the supporter 7 attached to the door 2 moves together with the door 2. Since the second portion 42 of the rod 4 is supported by the supporter 7, the rod 4 also moves together with the door 2. At this point, a movement direction of the first portion 41 of the rod 4 is restricted by the guide 56. Specifically, the first portion 41 moves in the direction substantially coincident with the length direction of the first portion 41 according to opening or closing of the door 2. Thus, when the rod 4 moves together with the door 2, the first portion 41 is guided by the guide 56, and accordingly, the second portion 42 rotates relative to each bush 73.

The first portion 41 has an engagement portion 43 to be engaged with the stopper 5 when the door 2 is opened to a predetermined degree of opening. The engagement portion 43 is provided at a portion of the first portion 41 positioned on the opposite side of the restriction piece 54 from the second portion 42. The engagement portion 43 of this example is a nut provided at an end portion of the first portion 41 on the side opposite to the second portion 42.

The door stopper 3 further includes a buffer 8 that damps impact of collision between the stopper 5 and the engagement portion 43. The buffer 8 is provided at the first portion 41. The buffer 8 of this example is a tubular rubber provided along an outer peripheral surface of the first portion 41. Note that other members such as a washer 44 provided at the first portion 41 may be or may not be interposed between the buffer 8 and the engagement portion 43.

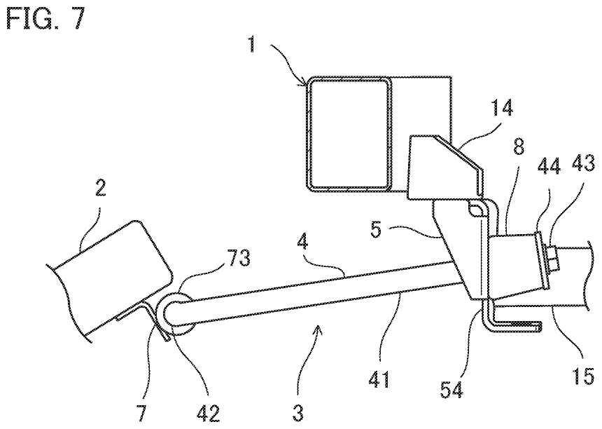

FIG. 6 is a plan view of the door stopper 3 when the door 2 is closed. FIG. 7 is a plan view of the door stopper 3 when the door 2 is opened. When the door 2 is closed, the first portion 41 of the rod 4 greatly protrudes from the restriction piece 54 of the stopper 5 to the side opposite to the door 2, as shown in FIG. 6. A portion of the first portion 41 protruding from the restriction piece 54 to the side opposite to the door 2 is positioned at the front of the dashboard 16, and is covered with the dashboard 16.

When the door 2 rotates in an opening direction thereof, the rod 4 is pulled outward of the vehicle compartment 11 by the door 2, and the first portion 41 moves outward of the vehicle compartment 11 along the guide 56. Accordingly, the engagement portion 43 of the first portion 41 moves in a direction toward the restriction piece 54. When the door 2 is opened to the predetermined degree of opening, the engagement portion 43 indirectly engages with the restriction piece 54 through the buffer 8, as shown in FIG. 7. Engagement between the first portion 41 and the stopper 5 as described above stops movement of the rod 4 to the outside of the vehicle compartment 11. That is, the relative movement of the first portion 41 and the stopper 5 when the door 2 is opened is restricted. As a result, rotation of the door 2 in the opening direction thereof is limited.

When the door 2 rotates in a closing direction thereof, the rod 4 is pushed and moved inward of the vehicle compartment 11 by the door 2, and accordingly, the first portion 41 moves inward of the vehicle compartment 11 along the guide 56. The first portion 41 moves inward of the vehicle compartment 11 along the guide 56 until the door 2 is closed.

At the above-described door stopper 3, both the first portion 41 engaging with the stopper 5 and the second portion 42 rotatably supported by the door 2 are integrally formed as the rod 4, i.e., a single member. Thus, as compared to a door stopper requiring two members, i.e., a member engaging with a stopper 5 and a member rotatably supported by a door 2, the number of components of the door stopper 3 can be reduced and the configuration of the door stopper 3 can be simplified.

In addition, the first portion 41 of the rod 4 and the second portion 42 of the rod 4 bent from the first portion 41 are integrally formed, and therefore, the strength of the rod 4 can be improved. Specifically, as shown in FIG. 7, when the door 2 is opened to the predetermined degree of opening and the engagement portion 43 and the restriction piece 54 engage with each other, a load in the opening direction of the door 2 is applied to the second portion 42 from the door 2 through the supporter 7. Such a load is received by the entirety of the rod 4. That is, at the rod 4, stress is dispersively generated not only at a portion of the second portion 42 supported by the supporter 7 but also the entirety of the second portion 42 and the first portion 41. Thus, the strength of the rod 4 is improved. Consequently, the configuration of the door stopper 3 can be simplified while the strength of the door stopper 3 is improved.

The stopper 5 is provided at the vehicle body 1, and the rod 4 is provided at the door 2. Thus, the first portion 41 can be moved at the periphery of the stopper 5 by means of a space in the vehicle body 1. That is, a space where the first portion 41 can be moved needs to be ensured at the periphery of the stopper 5 to move the first portion 41 relative to the stopper 5 and engage the first portion 41 with the stopper 5, and such a space can be provided in the vehicle body 1. Thus, the door stopper 3 can be placed using the space in the vehicle body 1 even in a case where the space is difficult to be ensured in the door 2, such as a case where the thickness of the door 2 is small. Moreover, since the space where the first portion 41 can be moved is provided in the vehicle body 1, the first portion 41 can be, when the door 2 is closed, arranged at the front of the dashboard 16 and covered with the dashboard 16, and therefore, the door stopper 3 can be less noticeable.

The stopper 5 is formed integrally with the bracket for attaching the dashboard frame 15 to the front pillar 14. That is, the stopper 5 also serves as the bracket for attaching the dashboard frame 15 to the front pillar 14. Thus, an additional bracket for attaching the dashboard frame 15 to the front pillar 14 does not need to be provided in the utility vehicle 10. Consequently, the number of components of the utility vehicle 10 can be reduced, and the configuration of the utility vehicle 10 can be simplified.

The engagement portion 43 of the rod 4 and the restriction piece 54 of the stopper 5 engage with each other through the buffer 8, and impact of collision between the engagement portion 43 and the restriction piece 54 is damped by the buffer 8. Thus, when the engagement portion 43 and the restriction piece 54 engage with each other, the load on the rod 4 is reduced. Consequently, the strength of the door stopper 3 can be further enhanced. Moreover, e.g., the size or hardness of the buffer 8 can be changed so that the strength of the door stopper 3 can be changed to a strength suitable for various doors 2 with, e.g., different weights or sizes.

As described above, the door stopper 3 includes the stopper 5 provided at a first object that is one of the vehicle body 1 or the door 2 and the rod 4 rotatably provided at a second object that is the other one of the vehicle body 1 or the door 2. The rod 4 has the first portion 41 and the second portion 42 bent from the first portion 41 and rotatably supported by the second object. The first portion 41 of the rod 4 and the stopper 5 move relative to each other according to opening or closing of the door 2. The first portion 41 of the rod 4 engages with the stopper 5 when the door 2 is opened to the predetermined degree of opening. The door stopper 3 restricts the relative movement of the first portion 41 and the stopper 5 by engagement between the first portion 41 and the stopper 5 to limit the degree of opening of the door 2.

In other words, the utility vehicle 10 (the off-road vehicle) includes the vehicle body 1, the doors 2, and the door stoppers 3. The door stopper 3 includes the stopper 5 provided at the first object that is one of the vehicle body 1 or the door 2 and the rod 4 rotatably provided at the second object that is the other one of the vehicle body 1 or the door 2. The rod 4 has the first portion 41 and the second portion 42 bent from the first portion 41 and rotatably supported by the second object. The first portion 41 of the rod 4 and the stopper 5 move relative to each other according to opening or closing of the door 2. The first portion 41 of the rod 4 engages with the stopper 5 when the door 2 is opened to the predetermined degree of opening. The door stopper 3 restricts the relative movement of the first portion 41 and the stopper 5 by engagement between the first portion 41 and the stopper 5 to limit the degree of opening of the door 2.

According to these configurations, both the first portion 41 engaging with the stopper 5 and the second portion 42 rotatably supported by the door 2 are integrally formed as the rod 4, i.e., the single member. Thus, as compared to the door stopper requiring two members, i.e., the member engaging with the stopper 5 and the member rotatably supported by the door 2, the number of components of the door stopper 3 can be reduced and the configuration of the door stopper 3 can be simplified. Further, the first portion 41 and the second portion 42 bent from the first portion 41 are integrally formed, and therefore, the load applied to the second portion 42 when the stopper 5 and the first portion 41 engage with each other can be received by the first portion 41 and the second portion 42. Thus, the configuration of the door stopper 3 can be simplified while the strength of the door stopper 3 is improved.

The first object is the vehicle body 1, and the second object is the door 2.

According to this configuration, the first portion 41 can be moved at the periphery of the stopper 5 by means of the space in the vehicle body 1. Thus, even in a case where the space is difficult to be ensured in the door 2, the door stopper 3 can be placed using the space in the vehicle body 1.

The stopper 5 includes the bracket that connects the front pillar 14 (the first frame) and the dashboard frame 15 (the second frame) to each other.

According to this configuration, in a vehicle provided with a door stopper 3, an additional bracket for connecting a front pillar 14 and a dashboard frame 15 to each other does not need to be provided separately from a stopper 5. Thus, the number of components of the vehicle can be reduced, and the configuration of the vehicle can be simplified.

The door stopper 3 further includes the buffer 8 provided at the first portion 41 of the rod 4. When the door 2 is opened to the predetermined degree of opening, the stopper 5 and the first portion 41 engage with each other through the buffer 8.

According to this configuration, when the first portion 41 of the rod 4 and the stopper 5 engage with each other, the load applied to the rod 4 can be reduced, and the strength of the door stopper 3 can be further enhanced. Moreover, e.g., the size or hardness of the buffer 8 is changed so that the strength of the door stopper 3 can be changed to a strength suitable for various doors 2 with, e.g., different weights or sizes.

### Other Embodiments

The embodiment has been described above as an example of the technique disclosed in the present application. However, the technique in the present disclosure is not limited to above, and is also applicable to embodiments to which changes, replacements, additions, omissions, etc. are made as necessary. The components described in the above-described embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

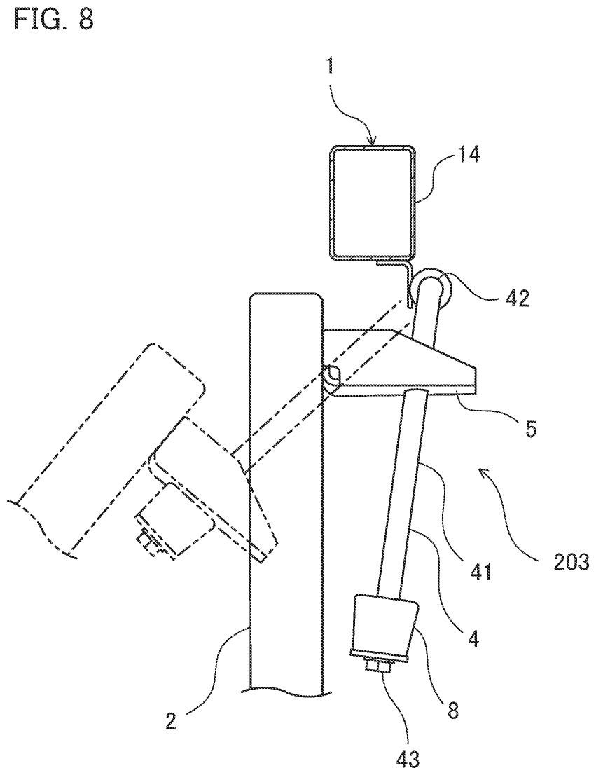

FIG. 8 is a plan view of a door stopper 203 of a variation. Note that in FIG. 8, the door stopper 203 when a door 2 is closed is indicated by solid lines and the door stopper 203 when the door 2 is opened is indicated by chain double-dashed lines. The door stopper 203 is different from the door stopper 3 in that a stopper 5 is provided at the door 2 and a rod 4 is rotatably provided at a vehicle body 1. That is, a first object of the door stopper 203 of this example is the door 2, and a second object of the door stopper 203 is the vehicle body 1.

The above-described embodiment and variation can be changed as necessary. For example, the utility vehicle 10 is not limited to the four-wheeled vehicle, and may be, e.g., a two-wheeled vehicle or a three-wheeled vehicle. The door stopper 3 may be provided at the door 2 at a rear portion of the vehicle compartment 11.

The shape, material, size, etc. of the stopper 5 are not limited. The stopper 5 may be attached to the vehicle body 1 by a method other than the method using the bolt and the nut. For example, the stopper 5 may be attached to the vehicle body 1 with a screw or a rivet or by welding. The bracket integrally formed with the stopper 5 is not limited to the bracket for attaching the dashboard frame 15 to the front pillar 14. The stopper 5 may be, for example, formed integrally with a bracket for attaching a subframe other than the dashboard frame 15 to the front pillar 14 or another main frame. The stopper 5 is not limited to one formed integrally with the bracket for attaching the frame to another frame. The stopper 5 may be provided at a member other than the frame in the vehicle body 1. It may only be required that the member to be attached to the fixing piece 57 is a member other than the stopper 5, and such a member is not limited to the dashboard 16. The fixing piece 57 may be omitted. The shape, size, material, etc. of the guide 56 are not limited. The guide 56 may be made of metal coated with resin.

The shape, material, size, etc. of the rod 4 are not limited. The engagement portion 43 of the rod 4 is not limited to the nut. The engagement portion 43 may be, for example, a member provided at the first portion 41 other than the nut or part of the first portion 41. The engagement portion 43 and the stopper 5 may directly contact and engage with each other. That is, it may only be required that the engagement portion 43 and the stopper 5 directly engage with each other or indirectly engage with each other through other members. The shape, material, size, etc. of the supporter 7 are not limited.

The buffer 8 is not limited to the rubber, and may be a member, such as a spring, having elasticity other than the rubber or a damper. The buffer 8 is not necessarily provided at the rod 4, but may be provided at the stopper 5. That is, it may only be required that the buffer 8 is provided at one of the rod 4 or the stopper 5. The buffer 8 may be omitted.

What is claimed:

1. A door stopper comprising:
a stopper provided at a first object that is one of a vehicle body or a door, and
a rod rotatably provided at a second object that is the other one of the vehicle body or the door,
wherein the rod has a first portion and a second portion bent from the first portion and rotatably supported by the second object,
the first portion of the rod and the stopper move relative to each other according to opening or closing of the door,
the first portion of the rod engages with the stopper when the door is opened to a predetermined degree of opening, and
the door stopper restricts relative movement of the first portion and the stopper by engagement between the first portion and the stopper to limit a degree of opening of the door.

2. The door stopper of claim 1, wherein
the first object is the vehicle body, and
the second object is the door.

3. The door stopper of claim 2, wherein
the stopper includes a bracket that connects a first frame of the vehicle body and a second frame of the vehicle body to each other.

4. The door stopper of claim 1, further comprising:
a buffer provided at least at one of the first portion of the rod or the stopper,
wherein when the door is opened to the predetermined degree of opening, the stopper and the first portion engage with each other through the buffer.

5. An off-road vehicle comprising:
a vehicle body;
a door; and
a door stopper,
wherein the door stopper has a stopper provided at a first object that is one of the vehicle body or the door and a rod rotatably provided at a second object that is the other one of the vehicle body or the door,
the rod has a first portion and a second portion bent from the first portion and rotatably supported by the second object,
the first portion of the rod and the stopper move relative to each other according to opening or closing of the door,
the first portion of the rod engages with the stopper when the door is opened to a predetermined degree of opening, and
the door stopper restricts relative movement of the first portion and the stopper by engagement between the first portion and the stopper to limit a degree of opening of the door.
